(19) United States
(12) Patent Application Publication
(10) Pub. No.: US 2025/0379377 A1
(43) Pub. Date: Dec. 11, 2025

(54) FEMALE ELECTRICAL TERMINAL

(71) Applicant: Lear Corporation, Southfield, MI (US)

(72) Inventors: Chao Fang, Shanghai (CN); Zhipeng Bai, Shanghai (CN)

(73) Assignee: Lear Corporation, Southfield, MI (US)

(21) Appl. No.: 19/228,983

(22) Filed: Jun. 5, 2025

(30) Foreign Application Priority Data
Jun. 5, 2024 (CN) 202410725100.4

(51) Int. Cl. H01R 11/16; H01R 4/18; H01R 4/48

(52) U.S. Cl. CPC H01R 11/16; H01R 4/184; H01R 4/4811; H01R 4/4823; H01R 4/484

(57) ABSTRACT

A female electrical terminal comprising a hollow cylindrical housing and a contact spring. The contact spring including a first ring located within the housing, a second ring located within the housing spaced from the first axial end, and a plurality of corrugated contact strips extending axially from the first ring to the second ring.

### FIELD

This invention relates to a female electrical terminal, and more particularly to a female electrical terminal having a contact spring mounted in a housing.

### BACKGROUND

Female electrical terminals are known that provide convenient and quick electrical connections. Some female electrical terminals may employ a retention apparatus that does not provide a stable insertion force when connecting to a male terminal and may require an insertion force that is higher than is desired. Other female electrical terminals may be large, high cost to produce, or have a high contact resistance, which are also undesirable features of a female electrical terminal.

### SUMMARY

In accordance with some embodiments, a female electrical terminal comprises: a housing, comprising a hollow cylindrical shape, a first axial end and an opposed second axial end; and a contact spring including a first ring located within the housing adjacent to the first axial end, a second ring located within the housing spaced from the first axial end, and a plurality of corrugated contact strips extending axially from the first ring to the second ring, the plurality of corrugated contact strips spaced circumferentially around the first ring, each of the corrugated contact strips comprising a first portion disposed adjacent to a first end that is adjacent to the first ring and a second portion disposed adjacent to a second end that is adjacent to the second ring, the first portion comprising a first circumferential width, the second portion comprising a second circumferential width that is greater than the first circumferential width.

In accordance with some embodiments, a female electrical terminal comprises: a housing, comprising a hollow cylindrical shape, a first axial end and an opposed second axial end; and a contact spring including a first ring located within the housing adjacent to the first axial end, a second ring located within the housing spaced from the first axial end, and a plurality of corrugated contact strips extending axially from the first ring to the second ring, the first ring fixed relative to the first axial end and the second ring axially slidable within the housing.

Additional understanding of these examples can be obtained by review of the detailed description below, and the appended drawings.

### BRIEF DESCRIPTION OF THE DRAWINGS

FIG. 1 is a schematic, perspective, partially exploded view of an electrical terminal assembly, with a wire crimping portion shown prior to being deformed over a wire.

FIG. 2 is a schematic, cross-section view through a portion of a female electrical terminal.

FIG. 3 is a schematic, perspective view of a housing and wire crimping portion of the female electrical terminal, with the wire crimping portion shown prior to being deformed over a wire and retention features shown prior to being deformed over radially outward extending flanges.

FIG. 4 is a schematic, perspective view of a contact spring.

FIG. 5 is a schematic, side view of the contact spring after being partially formed.

FIG. 6 is a schematic, perspective view of a female electrical terminal.

FIG. 7 is a schematic, cross-section view through a portion of the female electrical terminal of FIG. 6.

### DETAILED DESCRIPTION

The following detailed description and the appended drawings describe and illustrate various example embodiments of a female electrical terminal. The description and illustration of these examples are provided to enable one skilled in the art to make and use a female electrical terminal according to this invention. They are not intended to limit the scope of the claims in any manner.

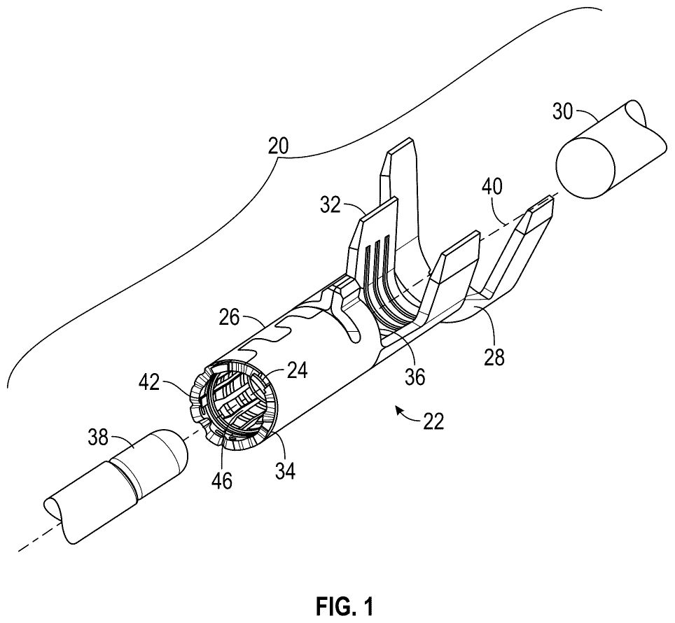

Referring now to the drawings, an example of an embodiment of an electrical terminal assembly 20 is illustrated in FIGS. 1-5. The electrical terminal assembly 20 has a female electrical terminal 22, which includes a contact spring 24 mounted in a housing 26. A wire crimping portion 28 extends axially from the housing 26 and is configured to receive an electrical wire 30, prior to flanges 32 on the wire crimping portion 28 being deformed to retain the electrical wire 30. The housing 26 and contact spring 24 define an opening at a first axial end 34 of the housing 26, opposite from a second axial end 36 from which the wire crimping portion 28 extends, which opening is sized to releasably receive a male terminal 38.

The term axial, as used herein, refers to a direction parallel to an axial axis 40 extending through a center of the housing 26. The term radial, as used herein, refers to a direction extending outward from the axial axis 40 in a perpendicular direction. The term circumferential, as used herein, refers to a direction extending circumferentially around the axial axis 40.

In an embodiment, the housing 26 and the wire crimping portion 28 are formed as a single monolithic piece. In an embodiment, the housing 26 and the wire crimping portion 28 are stamped and formed from a single piece of metal. FIG. 3 shows an embodiment of the housing 26 and the wire crimping portion 28 as a single monolithic piece prior to assembly of the contact spring 24 and the electrical wire 30. The housing 26 is an electrically conductive material formed into a hollow cylindrical shape. The flanges 32 of the wire crimping portion 28 are shown in an open position ready to receive the electrical wire 30, after which the flanges 32 are crimped around the electrical wire 30. The housing 26 includes retention features 33 extending axially outward from the first axial end 34.

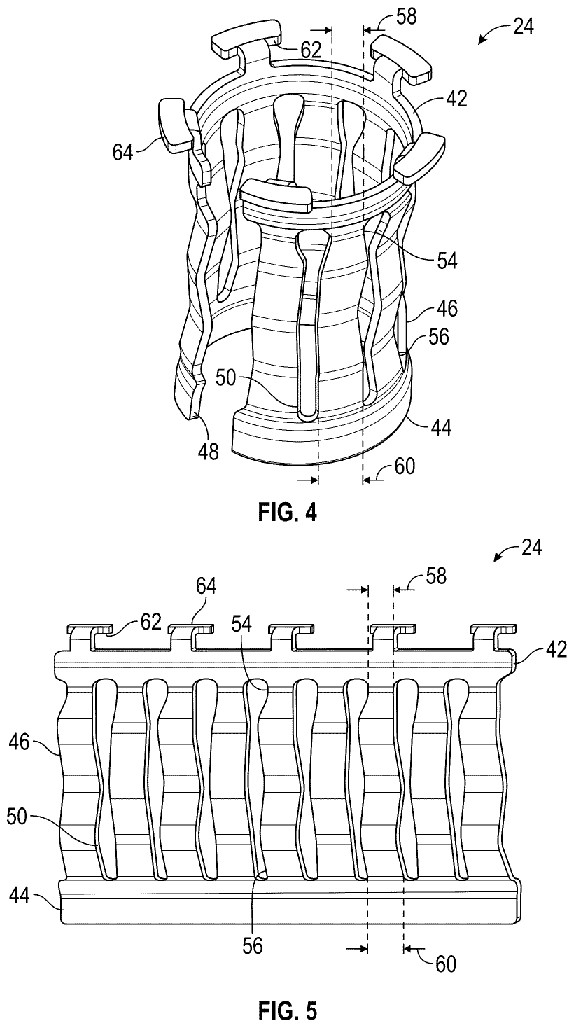

In an embodiment, the contact spring 24 is formed as a single monolithic piece. In an embodiment, the contact spring 24 is stamped and formed from a single piece of metal. FIGS. 4 and 5 show an embodiment of the contact spring 24 as a single monolithic piece. FIG. 4 illustrates the contact spring 24 in an essentially fully formed state while FIG. 5 illustrates the contact spring 24 is a partially formed state, prior to curving into a generally cylindrical shape.

The contact spring 24 includes a first ring 42 and a second ring 44, spaced axially from the first ring 42. In an embodiment, the rings 42, 44 extend around most of a circumference of a circle (e.g., essentially a fully circle), leaving a small gap 48 in the circumference prior to being inserted into the housing 26. The gap 48 may be reduced or eliminated when the contact spring 24 is inserted into the housing 26.

A plurality of corrugated contact strips 46 extend generally axially from the first ring 42 to the second ring 44 and air space circumferentially around an interior of the housing 26 when the contact spring 24 is disposed within the housing 26. The corrugated contact strips 46 are spaced apart circumferentially around the rings 42, 44, with axially extending gaps 50 between each adjacent corrugated contact strip 46. Adjacent ones of the corrugated contact strips 46 may have alternating corrugations. That is, one of the corrugated contact strips 46 may radially undulate from the first ring 42 radially inward, then radially outward, then radially inward as it extends toward the second ring 44, while an adjacent one of the corrugated contact strips 46 may radially undulate from the first ring 42 radially outward, then radially inward, then radially outward as it extends toward the second ring 44. In an embodiment, the corrugations, or the alternating of the corrugations, or both, may evenly disperse retention loads, electrical contacts, or both between the male terminal 38 and an inside surface 52 of the housing 26.

In an embodiment, each of the corrugated contact strips 46 includes a first portion 54 and a second portion 56. The first portion 54 is adjacent to the first ring 42. The second portion 56 extends axially from the second ring 44. The first portion 54 has a first circumferential width 58, and the second portion 56 has a second circumferential width 60 that is greater than the first circumferential width 58. In an embodiment, the second portion 56 extends from the first portion 54 to the second ring 44. The second portion 56 of each of the corrugated contact strips 46 is a remaining portion of each of the corrugated contact strips 46 other than the first portion 54.

In an embodiment, the contact spring 24 includes a plurality of radially outward extending flanges 62 that extend from the first ring 42. Radially outer ends 64 of the radially outward extending flanges 62 may have a greater circumferential width than the first circumferential width 58 adjacent to the first ring 42. The plurality of radially outward extending flanges 62 extending from the first ring 42 and are secured, or affixed, to the first axial end 34 of the housing 26.

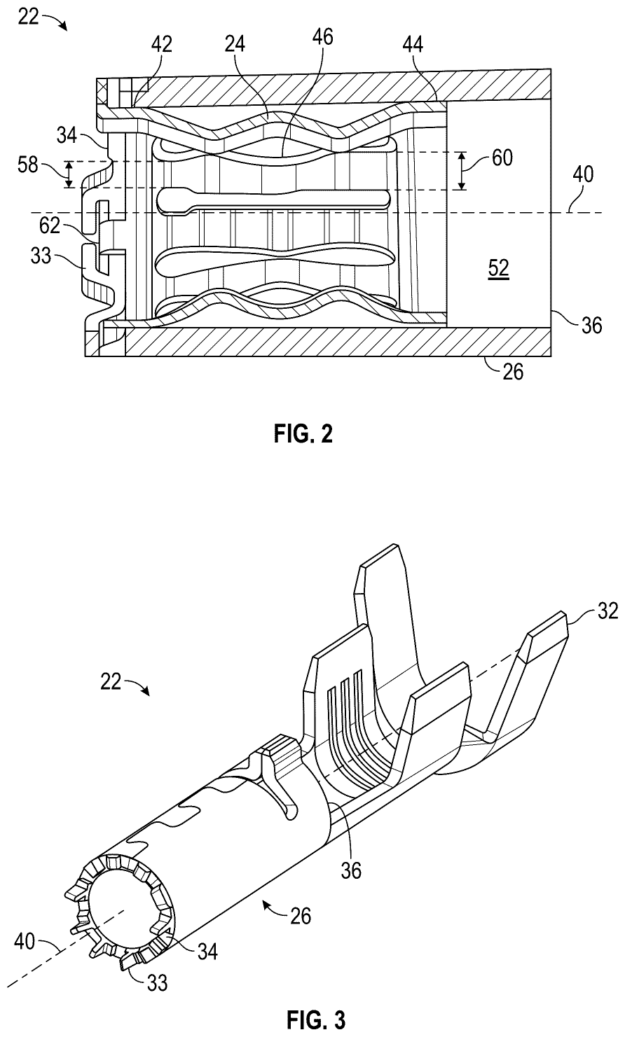

A discussion regarding assembly of the female electrical terminal 22 will now be discussed with reference to the example shown in FIGS. 1-5. After the housing 26 and wire crimping portion 28 have been formed (as illustrated in FIG. 3) and the contact spring 24 has been formed (as illustrated in FIG. 4), the contact spring 24 is inserted, second ring 44 first, through the first axial end 34 of the housing 26. The contact spring 24 may be radially compressed inward to ease this insertion. The contact spring 24 then slides into the housing 26 until the radially outward extending flanges 62 abut the first axial end 34 (best seen in FIG. 2). The retention features 33 are deformed over the radially outward extending flanges 62, which retains the contact spring 24 in the housing 26, including during insertion and removal of the male terminal 38. The retention features 33 operatively engage the radially outward extending flanges 62 to secure the contact spring 24 to the housing 26. In an embodiment, the radial compression of the contact spring 24 prior to insertion in the housing 26 allows for the contact spring 24 to elastically spring radially outward after insertion into engagement with the inside surface 52 of the housing 26 to provide contact for electrical conductivity, axially sliding of the second ring 44 within the housing 26, or both. In an embodiment, the axial sliding of the second ring reduces insertion force when inserting the male terminal 38 into the female electrical terminal 22, increases the removal force when removing the male terminal 38 from the female electrical terminal 22, or both. In an embodiment, the narrower first circumferential width 58 of the corrugated contact strips reduces the insertion force of the male terminal 38, provides a more consistent insertion force of the male terminal 38, or both.

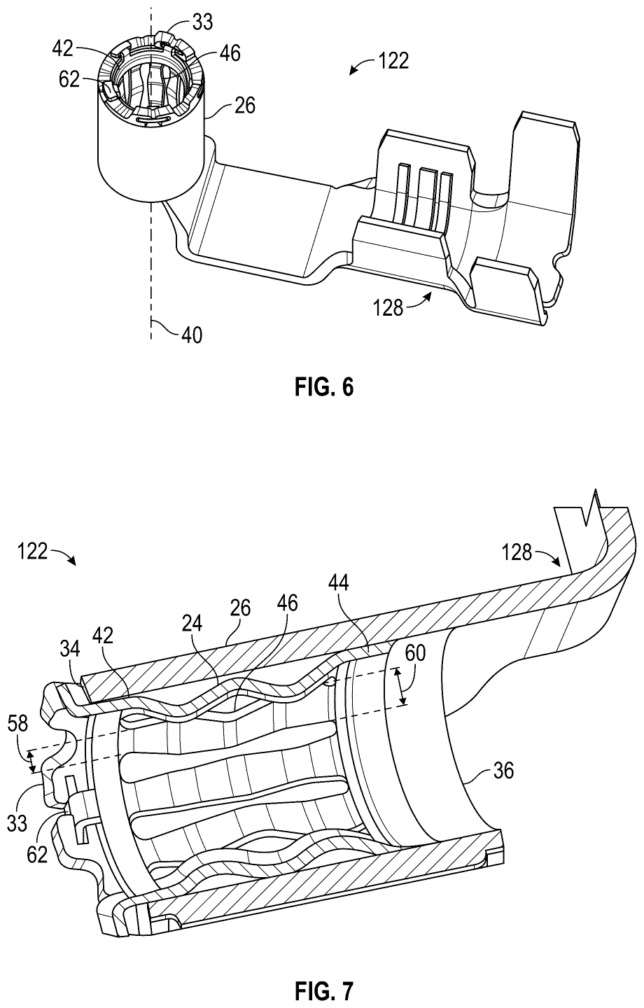

Referring now to FIGS. 6-7, in view of FIGS. 1-5, an example of a female electrical terminal 122 is illustrated. The example of a female electrical terminal 122 of FIGS. 6-7 has similar elements to those discussed relative to the example illustrated in FIGS. 1-5. The contact spring 24 and the housing 26 may be essentially the same as in the example of FIGS. 1-5 Accordingly, to avoid repetition, for those elements that are essentially the same, the same element numbers as used in FIGS. 1-5 are employed in FIGS. 6-7 without discussing those elements again. In an embodiment, the housing 26 and a wire crimping portion 128 are formed as a single monolithic piece. In an embodiment, the housing 26 and the wire crimping portion 128 are formed as a stamped piece of metal. In an embodiment, the wire crimping portion 28 receives a wire at an angle other than parallel to the axial axis 40 of the housing 26. In an embodiment, the wire crimping portion 28 receives a wire at an angle of about ninety degrees (e.g., nonparallel) from the axial axis 40. The assembly and use of the example of the female electrical connector 122 of FIGS. 6-7 may be essentially the same as in the example of FIGS. 1-5.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A female electrical terminal comprising:
a housing, comprising a hollow cylindrical shape, a first axial end and an opposed second axial end; and
a contact spring including a first ring located within the housing adjacent to the first axial end, a second ring located within the housing spaced from the first axial end, and a plurality of corrugated contact strips extending axially from the first ring to the second ring, the plurality of corrugated contact strips spaced circumferentially around the first ring, each of the corrugated contact strips comprising a first portion disposed adjacent to a first end that is adjacent to the first ring and a second portion disposed adjacent to a second end that is adjacent to the second ring, the first portion comprising a first circumferential width, the second portion comprising a second circumferential width that is greater than the first circumferential width.

2. The female electrical terminal of claim 1, wherein the second portion of each of the corrugated contact strips is a remaining portion of each of the corrugated contact strips other than the first portion.

3. The female electrical terminal of claim 1, wherein the first ring is fixed relative to the first axial end and the second ring is axially slidable within the housing.

4. The female electrical terminal of claim 3, wherein the contact spring includes a plurality of radially outward extending flanges extending from the first ring and secured to the first axial end of the housing.

5. The female electrical terminal of claim 4, wherein the housing includes retention features extending from the first axial end and operatively engaging the radially outward extending flanges to secure the contact spring to the housing.

6. The female electrical terminal of claim 3, wherein the plurality of corrugated contact strips are spaced circumferentially around an interior of the housing, with alternating corrugations of adjacent ones of the plurality of corrugated contact strips.

7. The female electrical terminal of claim 1, further comprising a wire crimping portion, wherein the housing and the wire crimping portion are a single monolithic piece.

8. The female electrical terminal of claim 1, wherein the contact spring is a single monolithic piece.

9. The female electrical terminal of claim 1, further comprising a wire crimping portion, wherein the housing has an axial axis, and wherein the axial axis is configured to be parallel to a wire crimped in the wire crimping portion.

10. The female electrical terminal of claim 1, further comprising a wire crimping portion, wherein the housing has an axial axis, and wherein the axial axis is configured to be nonparallel to a wire crimped in the wire crimping portion.

11. The female electrical terminal of claim 10, wherein the axial axis is configured to be perpendicular to the wire crimped in the wire crimping portion.

12. The female electrical terminal of claim 1, wherein the housing is electrically conductive.

13. The female electrical terminal of claim 1, wherein the first ring is essentially a full circle, and the second ring is essentially a full circle.

14. The female electrical terminal of claim 1, wherein the contact spring includes a plurality of radially outward extending flanges extending from the first ring and affixed to the first axial end of the housing.

15. The female electrical terminal of claim 1, wherein the plurality of corrugated contact strips are spaced circumferentially around an interior of the housing, with alternating corrugations of adjacent ones of the plurality of corrugated contact strips.

16. A female electrical terminal comprising:
a housing, comprising a hollow cylindrical shape, a first axial end and an opposed second axial end; and
a contact spring including a first ring located within the housing adjacent to the first axial end, a second ring located within the housing spaced from the first axial end, and a plurality of corrugated contact strips extending axially from the first ring to the second ring, the first ring fixed relative to the first axial end and the second ring axially slidable within the housing.

17. The female electrical terminal of claim 16, wherein the contact spring includes a plurality of radially outward extending flanges extending from the first ring and secured to the first axial end of the housing.

18. The female electrical terminal of claim 16, wherein the plurality of corrugated contact strips are spaced circumferentially around an interior of the housing, with alternating corrugations of adjacent ones of the plurality of corrugated contact strips.

19. The female electrical terminal of claim 16, wherein the housing is electrically conductive.

20. The female electrical terminal of claim 16, wherein the first ring is essentially a full circle, and the second ring is essentially a full circle.
